(19) United States
(12) Patent Application Publication
(10) Pub. No.: US 2007/0037934 A1
(43) Pub. Date: Feb. 15, 2007

(54) Method for the production of copolymers

(75) Inventors: Matthias Kluglein, Ludwigshafen (DE); Bernhard Lehmann, Bohl-Iggelheim (DE); Stephan Huffer, Ludwigshafen (DE); Friedrich Goffing, Neustadt (DE); Tanja Schneider, Bensheim (DE); Helmut Gumbel, Dannenfels (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/572,093

(22) PCT Filed: Sep. 14, 2004
(86) PCT No.: PCT/EP04/10244

§ 371 Date: Mar. 16, 2006

(30) Foreign Application Priority Data
Sep. 19, 2003 (DE) 103 43 904.8

(51) Int. Cl. C08F 12/08

(52) U.S. Cl. 525/333.3; 524/548

(57) ABSTRACT

A process for preparing copolymers which comprises copolymerizing (A) at least one ethylenically unsaturated dicarboxylic anhydride derived from at least one dicarboxylic acid having 4 to 8 carbon atoms, (B) at least one vinylaromatic compound, and (C) optionally at least one non-(A) ethylenically unsaturated comonomer containing at least one heteroatom,
(D) reacting the copolymer with at least one compound of the formula I a or I b 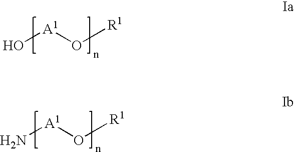 where
A¹ is C₂-C₂₀ alkylene, identical or different,
R¹ is C₁-C₃₀ alkyl, linear or branched, and n is an integer from 1 to 200, hydrolyzing the product with water or an aqueous alkaline solution, and subsequent to hydrolysis adding further free-radical initiator.

The present invention relates to a process for preparing copolymers which comprises copolymerizing
(A) at least one ethylenically unsaturated dicarboxylic anhydride derived from at least one dicarboxylic acid having 4 to 8 carbon atoms,
(B) at least one vinylaromatic compound, and
(C) optionally at least one non-(A) ethylenically unsaturated comonomer containing at least one heteroatom,
(D) reacting the copolymer with at least one compound of the formula I a or I b 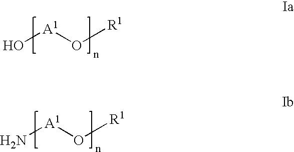
   where
A¹ is C₂-C₂₀ alkylene, identical or different,
R¹ is C₁-C₃₀ alkyl, linear or branched, and
n is an integer from 1 to 200,
   hydrolyzing the product with water or an aqueous alkaline solution, and subsequent to hydrolysis adding further initiator.

For producing leather it is possible to use polymers at the pretan, maintan, and retan stages. By using polymers for pretannage it is possible in many cases to do entirely, or at least partly, without Cr compounds. The choice of polymers can influence the properties of the end leather product. Regarding the choice of the polymers the literature makes a variety of proposals.

EP-A 0 628 085 describes the use of copolymers of maleic anhydride and, optionally, a second monomer, such as styrene, isobutene or vinyl acetate, for example, the copolymers being reacted with alkoxylated alcohols before being used for retanning and plumping.

EP-A 0 372 746 discloses the use of amphiphilic copolymers of methacrylic acid and, for example, cetyl eicosyl methacrylate (process example A) or of acrylic acid with α-hexadecene (process example C) for after treating leather. The use of such polymers is limited to the after treating of chrome-tanned leathers (see page 8, lines 50-54).

For the treatment of leathers, however, particularly soft leathers, the prior art polymers are still not optimal. For example, the leathers produced by the existing methods are capable of improvement in their fullness, grain quality, and surface properties. Moreover, the distribution of the fats used in retanning across the section of the leather is still not optimal.

Copolymers of partly polyethylene glycol-esterified maleic anhydride and styrene are known from other fields of application. Example 1 of EP-A 0 306 449, for example, describes preparing styrene-maleic monoester copolymers by copolymerizing styrene and maleic anhydride and then esterifying the initial copolymer with polyethylene glycol to give brown products possessing suitability as cement fluidizers.

The precise reasons why brown products are formed during the reaction described in example 1 of EP 0 306 449 are unknown.

EP-A 0 945 473 discloses processes for preparing styrene-maleic monoester copolymers. In one version the processes are performed in two stages (examples 1 to 3), meaning that a styrene-maleic anhydride copolymer is subjected to partial esterification. Such two-stage processes, however, are relatively complicated. In another version disclosed, which leads to colored products, the process is implemented in one stage (examples 7 to 9).

From EP-A 0 945 501 it is known that styrene-maleic monoester copolymers prepared by a two-stage process are suitable for use as an additive to laundry detergents comprising a builder and a surfactant. The synthesis process, however, is relatively complicated. Also, the cleaning effect of the styrene-maleic monoester copolymers disclosed is capable of improvement.

It is an object of the present invention to provide an improved process for preparing copolymers that avoids the weaknesses set out above and leads to products having little color.

We have found that this object is achieved by the process defined at the outset. Said process comprises copolymerizing with one another the following comonomers:
(A) at least one ethylenically unsaturated dicarboxylic anhydride derived from at least one dicarboxylic acid having 4 to 8 carbon atoms, examples being maleic anhydride, itaconic anhydride, citraconic anhydride, and methylenemalonic anhydride, preferably itaconic anhydride and maleic anhydride, and very preferably maleic anhydride;
(B) at least one vinylaromatic compound of, for example, the formula VIII 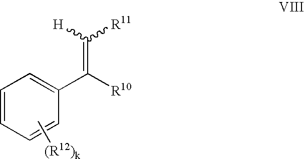
   where R¹⁰ and R¹¹ independently are each hydrogen, methyl or ethyl, R¹² is methyl or ethyl, and k is an integer from 0 to 2;
   preferably R¹⁰ and R¹¹ are each hydrogen and preferably k=0;
   and
(C) optionally at least one non-(A) ethylenically unsaturated comonomer containing at least one heteroatom.
   The copolymer is reacted with
(D) at least one compound of the formula I a or I b, preferably I a 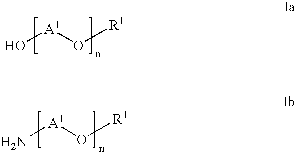
   where
A¹ is C₂-C₂₀ alkylene, such as —(CH₂)₂—, —CH₂—CH(CH₃)—, —(CH₂)₃—, —CH₂—CH(C₂H₅)—, —CH₂—CH(iso C₃H₇)—, —CH₂—CH(n C₄H₉)—, —(CH₂)₄—, —(CH₂)₅—, and —(CH₂)₆—, preferably C₂-C₄ alkylene; in particular —(CH₂)₂—, —CH₂—CH(CH₃)— and —CH₂—CH(C₂H₅)—;
R¹ is C₁-C₃₀ alkyl, linear or branched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, isodecyl, 2-propylheptyl, n-dodecyl, isotridecyl, linear and branched C₁₃ and C₁₅ alkyl, n-hexadecyl, n-octadecyl, and n-eicosyl; more preferably C₁-C₄ alkyl such as methyl, ethyl, n-propyl, isopropyl, n-butyl, isobutyl, sec-butyl and tert-butyl; and very preferably methyl; and
n is an integer from 1 to 200, preferably from 4 to 50.

The groups A¹ can of course only be different when n is a number greater than 1 or when different compounds of the formula I a and/or I b are used.

In one embodiment of the present invention mixtures of different components (D) of, for example, the formula I a are used. In particular it is possible to use mixtures of compounds of the formula I a in which—based in each case on the mixture—at least 95 mol%, preferably at least 98 mol% up to a maximum of 99.8 mol% of R¹ is C₁-C₃₀ alkyl and at least 0.2 mol% and not more than 5 mol%, preferably not more than 2 mol%, of R¹ is hydrogen.

After copolymerization and the reaction with (D) the product is hydrolyzed with water, an aqueous alkaline solution or dilute aqueous acid, preference being given to hydrolysis with water or with an aqueous alkaline solution.

In accordance with the invention, subsequent to hydrolysis, further initiator is added, it being possible for the initiator or initiators to be the same as or different from that or those used for the copolymerization.

Particular examples of compounds of the formula I a are
methyl-endcapped polyethylene glycols of the formula HO—(CH₂CH₂O)ₘ—CH₃ with m=1 to 200, preferably 4 to 100, more preferably 4 to 50
methyl-endcapped block copolymers of ethylene oxide, propylene oxide and/or butylene oxide having a molecular weight Mₙ of from 300 to 5000 g/mol
methyl-endcapped random copolymers of ethylene oxide, propylene oxide and/or butylene oxide having a molecular weight Mₙ of from 300 to 5000 g/mol
alkoxylated C₂ to C₃₀ alcohols, especially n-butanol alkoxylates, n-hexanol alkoxylates, fatty alcohol alkoxylates, oxo alcohol alkoxylates or Guerbet alcohol alkoxylates, the alkoxylation being performable with ethylene oxide, propylene oxide and/or butylene oxide; examples are
C₁₃-C₁₅ oxo alcohol ethoxylates having 3 to 30 ethylene oxide units
C₁₃ oxo alcohol ethoxylates having 3 to 30 ethylene oxide units
C₁₂C₁₄ fatty alcohol ethoxylates having 3 to 30 ethylene oxide units
C₁₀ oxo alcohol ethoxylates having 3 to 30 ethylene oxide units
C₁₀ Guerbet alcohol ethoxylates having 3 to 30 ethylene oxide units
C₉-C₁₁ oxo alcohol alkoxylates having 2 to 20 ethylene oxide units, 2 to 20 propylene oxide units and/or 1 to 5 butylene oxide units
C₄-C₂₀ alcohol alkoxylates having 2 to 20 ethylene oxide units, 2 to 20 propylene oxide units and/or 1 to 5 butylene oxide units
C₁₃-C₁₅ oxo alcohol alkoxylates having 2 to 20 ethylene oxide units, 2 to 20 propylene oxide units and/or 1 to 5 butylene oxide units
C₄-C₂₀ alcohol ethoxylates having 3 to 30 ethylene oxide units.

Preferred examples of compounds of the formula I b are methyl-endcapped polyethylene glycol amines of the formula H₂N—(CH₂CH₂O)ₘ—CH₃ with m=1 to 200, preferably 4 to 100, more preferably 4-50.

Comonomer (B) is preferably a-methylstyrene and very preferably styrene.

Comonomer (C) is very preferably one of the following: acrylic acid, methacrylic acid, methyl acrylate, methyl methacrylate, acrylamide, vinyl n-butyl ether, vinyl isobutyl ether, N-vinylformamide, N-vinylpyrrolidone, 1-vinylimidazole, and 4-vinylpyridine.

In one embodiment of the present invention first (A), (B), and, where used, (C) are copolymerized and the copolymer is then reacted with (D).

In another embodiment of the present invention the copolymerization of (A), (B), and, where used, (C) is conducted in the presence of all or portions of the compound (D) to be used.

The total amount of (D) is calculated by assuming complete reaction of (D) and employing from 5 to 80 mol%, preferably from 10 to 67 mol%, more preferably from 20 to 50 mol% of (D), based on all of the carboxyl groups in the copolymer. The term “all of the carboxyl groups in the polymer” is a reference, for the purposes of the present invention, to those carboxyl groups from copolymerized comonomers (A) and, where used, (C) that are in anhydride, C₁-C₄ alkyl ester or carboxylic acid form.

The copolymerization is advantageously started off using initiators, examples being decomposing radical compounds such as peroxides or hydroperoxides. Peroxides and hydroperoxides include for example di-tert-butyl peroxide, tert-butyl peroctoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, and dicyclohexyl peroxodicarbonate. Also suitable is the use of redox initiators, examples being combinations of hydrogen peroxide or sodium peroxodisulfate or one of the abovementioned peroxides with a reducing agent. Examples of suitable reducing agents include ascorbic acid, tartaric acid, Fe(II) salts such as FeSO₄, sodium bisulfite, and potassium bisulfite.

Further suitable initiators include azo compounds such as 2,2′-azobis(isobutyronitrile), 2,2′-azobis(2-methylpropionamidine) dihydrochloride, and 2,2′-azobis(4-methoxy-2,4-dimethylvaleronitrile).

Initiator is used generally in amounts of from 0.1 to 20% by weight, preferably from 0.2 to 15% by weight, calculated based on the mass of all the comonomers.

In one preferred embodiment no solvent or only small amounts of solvent, i.e., not more than 10% by weight, based on the total mass of comonomers (A), (B), and, where used, (C), is or are employed. By solvents are meant substances which are inert under the conditions of the copolymerization and esterification or amide formation, particularly aliphatic and aromatic hydrocarbons such as cyclohexane, n-heptane, isododecane, benzene, toluene, ethylbenzene, xylene isomer mixture, meta-xylene, and ortho-xylene, for example. If the reaction with (D) is conducted without an acidic catalyst then the copolymerization and/or reaction with (D) can also be conducted in solvents selected from ketones such as acetone or methyl ethyl ketone or from cyclic and noncyclic ethers such as tetrahydrofuran and di-n-butyl ether, for example.

The sequence of addition of the comonomers can be varied.

In one embodiment of the process of the invention a mixture of (D) and (A) is introduced initially and initiator together with (B) and, where used, (C) are added. It is preferred here to add (B) and, where used, (C) in the manner of a feed process.

In one embodiment of the present invention a mixture of (D) and (A) is introduced initially and initiator together with (B) and, where used, (C) are added in the manner of a feed process, with initiator, (B), and, where used, (C) each being in solution in (D).

In one embodiment of the present invention a mixture of (D) and (A) is introduced initially and initiator and (B) and (C) are added in the manner of a feed process, the feed rates chosen for (B) and (C) being different.

In another embodiment of the present invention a mixture of (D) and (A) is introduced initially and initiator and (B) and (C) are added in the manner of a feed process, the feed rates chosen for (B) and (C) being the same.

In one embodiment of the present invention further initiator is added during the addition of (B) and, where used, (C).

In one embodiment of the present invention the molar ratio of (A) to (B) is from 1:0.1 to 1:10, preferably from 1:0.2 to 1:1, more preferably from 1:0.3 to 1:0.98, and very preferably from 1:0.4 to 1:0.97.

In one embodiment of the present invention the molar ratio of (A) to (C) is from 1:0 to 1:10, preferably from 10:1 to 1:1, very preferably from 9:1 to 4:1.

In one embodiment of the present invention the molar ratio of (A) to [(B)+(C)] is from 2:1 to 1:20, preferably from 1.5:1 to 1:10, very preferably from 1.1:1 to 1:6.

In one embodiment of the present invention the temperature for the copolymerization of (A), (B), and, where used, (C) is in the range from 40 to 120° C., preferably from 60 to 115° C.

The pressure during the copolymerization can be in the range, for example, of from 1 to 10 bar, preferably from 1 to 3 bar.

Regulators can be used, examples being mercaptoethanol and n-dodecyl mercaptan. Suitable amounts are from 0.1 to 6% by weight, for example, based on the mass of the comonomers employed. It is preferred to operate in the absence of regulators.

Small amounts of one or more polymerization inhibitors can be added during the copolymerization, hydroquinone monomethyl ether being one example. Polymerization-inhibitor can be metered in advantageously with (B) and, where used, (C). Suitable-amounts of polymerization inhibitor are from 0.01 to 1% by weight, preferably from 0.05 to 0.1% by weight, calculated based on the mass of all the comonomers. Adding polymerization inhibitor is especially preferable when the copolymerization is conducted at temperatures above 80° C.

When the addition of (B), optionally (C), optionally (D), and optionally initiator is complete, reaction can be allowed to continue.

The copolymerization time is generally from 0.5 to 8 hours, preferably from 1 to 5 hours.

The duration of the reaction with (D) can amount to from 0.5 to 8 hours, preferably from 1 to 5 hours.

If the process of the invention is conducted such that (A), (B) and, if used, (C) are copolymerized in the presence of the entirety of (D), then a reaction time totaling from 0.5 to 8 hours, preferably from 1 to 5 hours, is appropriate.

The reaction with (D) can be conducted in the absence or in the presence of catalysts, particularly acidic catalysts such as sulfuric acid, methanesulfonic acid, p-toluenesulfonic acid, n-dodecylbenzenesulfonic acid, hydrochloric acid or acidic ion exchangers, for example.

In one embodiment of the present invention the reaction with (D) is conducted in the absence of catalysts at a temperature in the range from 60 to 130° C., preferably from 100 to 120° C.

In one embodiment of the present invention the reaction with (D) is conducted in the presence of catalysts. The duration of the reaction with (D) can amount to from 0.25 to 1 hour.

In one embodiment of the present invention the reaction with (D) is conducted in the presence of acidic catalysts at a temperature in the range from 80 to 95° C.

In a further version of the process described the reaction with (D) is conducted in the presence of an azeotrope former which forms an azeotrope with any water produced in the reaction.

Generally speaking, under the conditions of the steps described above, (D) reacts completely or to a certain percentage with the carboxyl groups of copolymerized anhydrides (A) and, where present, the carboxyl groups from copolymerized (C). Generally less than 40 mol% of unreacted (D) remains.

It is possible to use conventional methods such as extraction, for example, to remove unreacted (D) from the copolymers obtainable by the process of the invention.

The monomer or monomers (C) copolymerizable optionally in the process of the invention is or are different than (A). Preferred non-(A) monomers (C) containing at least one heteroatom include the following:
C₃-C₈ carboxylic acid derivatives of the formula II, 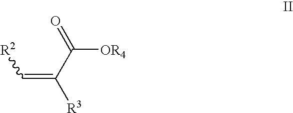
acrylamides of the formula III, 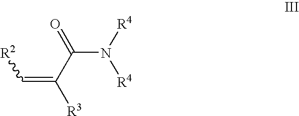
noncyclic amides of the formula IV a and cyclic amides of the formula IV b, 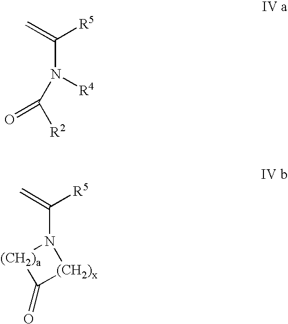
C₁-C₂₀ alkyl vinyl ethers such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether;
N-vinyl derivatives of aromatic nitrogen compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline, and N-vinyl-2-methylimidazoline; α,β-unsaturated nitriles such as acrylonitrile or methacrylonitrile;
alkoxylated unsaturated ethers of the formula V, 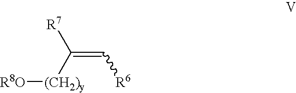
esters and amides of the formula VI, 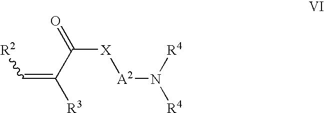
unsaturated esters of the formula VII, 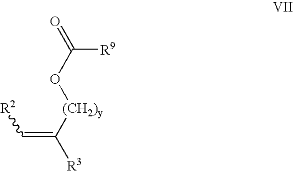
phosphate-, phosphonate-, sulfate-, and sulfonate-functional comonomers such as 2-{(meth)acryloyloxy}ethyl phosphate, and 2-(meth)acrylamido-2-methyl-1-propanesulfonic acid;
where
A² is C₂-C₂₀ alkylene, such as —(CH₂)₂—, —CH₂—CH(CH₃)—, —(CH₂)₃—, —CH₂—CH(C₂H₅)—, —CH₂—CH(iso C₃H₇)—, —CH₂—CH(n C₄H₉)—, —(CH₂)₄—, —(CH₂)₅—, and —(CH₂)6—; preferably C₂-C₄ alkylene; in particular —(CH₂)₂—, —CH₂—CH(CH₃)— and —CH₂—CH(C₂H₅)—;
R² and R³ are identical or different and are selected from branched or unbranched C₁-C₅ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, and isoamyl, more preferably C₁-C₄ alkyl such as methyl, ethyl, n-propyl, isopropyl, n-butyl, isobutyl, sec-butyl and tert-butyl;
and especially hydrogen;
R⁴ is identical or different at each occurrence and is C₁-C₂₂ alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, and n-eicosyl; more preferably C₁-C₄ alkyl such as methyl, ethyl, n-propyl, isopropyl, n-butyl, isobutyl, sec-butyl, and tert-butyl; or very preferably hydrogen;
R⁵ is hydrogen or methyl;
x is an integer from 2 to 6, preferably from 3 to 5;
y is an integer 0 or 1, preferably 1;
a is an integer from 0 to 6, preferably from 0 to 2;
R⁶ and R⁷ are identical or different and are selected from hydrogen and branched or unbranched C₁-C₁₀ alkyl as defined above;
X is oxygen or N—R⁴;
R⁸ is [A¹—O]ₙ—R⁴;
R⁹ is selected from branched or unbranched C₁-C₂₀ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl, n-hexadecyl, n-octadecyl, and n-eicosyl; preferably C₁-C₁₄ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, and n-tetradecyl;
and especially hydrogen or methyl.

The remaining variables are as defined above.

Compounds of the formula III selected by way of example are (meth)acrylamides such as acrylamide, N-methylacrylamide, N,N-dimethylacrylamide, N-ethylacrylamide, N-propylacrylamide, N-tert-butylacrylamide, N-tert-octylacrylamide, N-undecylacrylamide, and the corresponding methacrylamides.

Compounds of the formula IV a selected by way of example are N-vinylcarboxamides such as N-vinylformamide, N-vinyl-N-methylformamide, N-vinylacetamide or N-vinyl-N-methylacetamide; representatives of compounds of the formula IV b selected by way of example are N-vinylpyrrolidone, N-vinyl-4-piperidone, and N-vinyl-ε-caprolactam.

Compounds of the formula VI selected by way of example are (meth)acrylic esters and (meth)acrylamides such as N,N-dialkylaminoalkyl (meth)acrylates or N,N-dialkylaminoalkyl(meth)acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, 2-(N,N-dimethylamino)ethylacrylamide, 2-(N,N-dimethylamino)ethylmethacrylamide, 2-(N,N-diethylamino)ethylacrylamide, 2-(N, N-diethylamino)ethylmethacrylamide, 3-(N,N-dimethylamino)propylacrylamide, and 3-(N,N-dimethylamino)propylmethacrylamide.

Compounds of the formula VII selected by way of example are vinyl acetate, allyl acetate, vinyl propionate, vinyl butyrate, vinyl 2-ethylhexanoate, and vinyl laurate.

In one embodiment it is possible to omit the further step of removing unreacted (D) from the copolymers prepared in accordance with the invention. In this embodiment copolymers together with a certain percentage of unreacted (D) are used for producing leather or as an additive to detergents.

The copolymerization described above produces copolymers. The copolymers obtained can be subjected to purification by conventional methods, such as by reprecipitation or extractive removal of unreacted monomers. If a solvent or precipitant has been used then it is possible to remove it when copolymerization is at an end, by distillation, for example.

Following the copolymerization the copolymers are reacted with water or with an aqueous alkaline solution to give aqueous solutions or dispersions of copolymers, which may be partly or fully hydrolyzed. This step is referred to below as hydrolysis.

In accordance with the invention the hydrolysis is conducted such that the copolymers prepared in accordance with the invention are reacted with water or an aqueous alkaline solution, such as, for example, a solution of alkali metal hydroxides such as sodium hydroxide or potassium hydroxide, alkali metal carbonates such as sodium carbonate or potassium carbonate, alkali metal hydrogen carbonates such as potassium hydrogen carbonate, ammonia, primary, secondary or tertiary alkylamines or alkanolamines. Particularly suitable are sodium hydroxide or potassium hydroxide solution. For example, about 30 to 150% by weight of water or aqueous alkaline solution is used, based on copolymer prepared in accordance with the invention. Hydrolysis can be carried out using dilute aqueous acid, such as from 0.5 to 5% by weight of sulfuric acid or from 0.5 to 10% by weight of citric acid.

The temperature during the hydrolysis is generally not critical. Suitable temperatures are generally from 20 to 100° C., preferably up to 90° C. Hydrolysis is normally over after 10 minutes to 4 hours.

Following hydrolysis further initiator is added—peroxides or hydroperoxides, for example. Examples of peroxides and hydroperoxides include tert-butyl hydroperoxide and hydrogen peroxide. The use of redox initiators is suitable as well, examples being combinations of hydrogen peroxide or sodium peroxodisulfate or one of the abovementioned peroxides with a reducing agent. Examples of suitable reducing agents include ascorbic acid, tartaric acid, Fe(II) salts such as FeSO₄, sodium bisulfite, and potassium bisulfite.

Further suitable initiators are azo compounds such as 2,2′-azobis(isobutyronitrile), 2,2′-azobis(2-methylpropionamidine) dihydrochloride, and 2,2′-azobis(4-methoxy-2,4-dimethylvaleronitrile). Particular preference is given to hydrogen peroxide, sodium peroxodisulfate, and tert-butyl hydroperoxide and to redox initiators.

The further addition of initiator generally involves amounts of from 0.1 to 20% by weight, preferably from 0.2 to 15% by weight, calculated based on the mass of all the comonomers.

It is possible to add the same initiator used for initiating the copolymerization or, preferably, at least one different initiator.

Reaction can be allowed to continue after further initiator has been added, for a period of from 0.5 to 5 hours, for example.

In one embodiment of the present invention further initiator is added and, if desired, reaction allowed to continue at a temperature in the range from 20 to 100° C., preferably from 25 to 70° C.

In one embodiment of the present invention the further addition of initiator and, if desired, continued reaction are conducted at a pressure in the range from 0.5 to 10 bar, preferably at atmospheric pressure.

In one embodiment of the present invention the further addition of initiator and, where appropriate, continued reaction are conducted after hydrolysis and prior to neutralization.

In one embodiment of the present invention the addition of redox initiators is made after the hydrolysis. First oxidizing agent is added and then, after neutralization, reducing agent. The continued reaction takes place before and after the neutralization.

Aqueous dispersions or aqueous solutions of copolymers prepared in accordance with the invention, also referred to below as aqueous copolymer dispersions, are obtained in which some or all of the anhydride groups not reacted in the reaction with (D) are in hydrolyzed form and carboxylic acid groups are present free or in the form of their alkali metal or ammonium salts.

The present invention further provides copolymers obtainable by the process of the invention.

Copolymers of the invention are normally obtained in the form of aqueous dispersions or solutions. Copolymers of the invention can be isolated from aqueous dispersions of the invention by methods known per se to the skilled worker, such as by evaporation of water or by spray drying, for example.

The polydispersity of copolymers of the invention is generally between 2 and 20, preferably up to 15.

The K values of copolymers of the invention are from 6 to 100, preferably from 10 to 60 (measured by the method of H. Fikentscher at 25° C. in water at a polymer concentration of 2% by weight).

With regard to (A), (B), and, where used, (C), copolymers of the invention can be block copolymers, alternating copolymers or random copolymers, preference being given to alternating copolymers in respect of (A) and (B).

The color number, also called APHA color number, of 33% by weight aqueous solutions of copolymer of the invention is below 150, preferably below 100, as measured by the Hazen method in accordance with EN 1557: Colorimetric characterization of optically clear colored liquids.

In one embodiment of the present invention the absorbance of 33% by weight aqueous solutions of copolymer of the invention at 450 nm is not more than 0.25.

In one embodiment of the present invention copolymers of the invention contain from 1 to 100 ppm of residual monomer, as determined by gas chromatography in accordance with the method described in Dispersionshandbuch (section C 2.4.7.4 (1994)). In the case of the present invention residual monomer means (B) present freely in the copolymer.

For many applications it is unnecessary to isolate copolymer of the invention: the aqueous dispersions or solutions obtained through the process of the invention can be used without further workup. Aqueous dispersions and solutions comprising copolymer of the invention are therefore likewise provided by the present invention.

In one embodiment of the present invention aqueous dispersions and solutions of the invention comprising copolymer of the invention have a pH of from 4 to 8, preferably from 5 to 7.

In one embodiment of the present invention aqueous dispersions and solutions of the invention comprising copolymer of the invention have a solids content of from 30 to 70% by weight, preferably from 40 to 65% by weight.

The present invention further provides for the use of the copolymers of the invention for producing leather. The present invention additionally provides a process for producing leather using the copolymers of the invention.

Copolymers of the invention can be employed at the pretan, tan or retan stage.

The process of the invention for producing leather can be implemented as a process for pretanning or tanning, also referred to below as a tanning process of the invention. The tanning process of the invention starts from conventionally pretreated animal hides, such as those of cattle, pigs, goats or deer, for example, which are called pelts. For the tanning process of the invention it is immaterial whether the animals have been killed by slaughtering, for example, or have died of natural causes. Conventional pretreatment methods include, for example, liming, deliming, bating, and pickling, and also mechanical operations, such as fleshing of the hides.

The tanning process of the invention is generally performed by adding copolymer of the invention in one or more portions immediately before or else during the tanning step. The tanning process of the invention is preferably conducted at a pH of from 2.5 to 4, a frequent observation being an increase in pH by about 0.3 to three units while the tanning process of the invention is being carried out. The pH can also be increased by about 0.3 to three units by adding basifying agents.

The tanning process of the invention is generally conducted at temperatures from 10 to 45°, preferably from 20 to 30° C. A duration of from 10 minutes to 12 hours, preferably from one to three hours, has proven useful. The tanning process of the invention can be carried out in any desired customary tannery vessels: for example, by drumming in barrels or in rotating drums.

In one version of the tanning process of the invention copolymer of the invention is employed together with one or more conventional tanning agents, such as with chrome tanning agents, mineral tanning agents, syntans, polymer tanning agents or vegetable tanning agents, as described in, for example, Ullmann's Encyclopedia of Industrial Chemistry, Volume A15, pages 259 to 282 and especially page 268 ff., 5^{th} edition, (1990), Verlag Chemie Weinheim. The weight ratio of copolymer of the invention to conventional tanning agent or to the sum of conventional tanning agents is advantageously from 0.01:1 to 100:1.

In one version of the tanning process of the invention copolymer of the invention is added in one or more portions before or during pretanning, in one particular version as early as during pickling.

The process of the invention for producing leather can also be implemented as a process for retanning leather using copolymer of the invention, also referred to below as retanning process of the invention. The retanning process of the invention starts from semifinished products tanned conventionally, i.e., for example, with chrome tanning agents, mineral tanning agents, polymer tanning agents, aldehydes, syntans or resin tanning agents, or from semifinished products produced in accordance with the invention as described above. For carrying out the retanning of the invention copolymer of the invention is caused to act on semifinished products.

The retanning process of the invention can be carried out under otherwise customary conditions. Advantageously one or more, i.e., 2 to 6, action steps are selected, and washing with water can be carried out between the action steps. The temperature during the individual action steps is in each case from 5 to 60° C., preferably from 20 to 45° C. It is advantageous to employ further compositions conventionally used during retanning, examples being fatliquors, polymer tanning agents, and acrylate- and/or methacrylate-based fatliquoring agents, retanning agents based on resin and vegetable tanning agents, fillers, leather dyes, and emulsifiers.

A further aspect of the present invention are leathers produced by the tanning process or retanning process of the invention or by a combination of tanning and retanning processes of the invention. The leathers of the invention are distinguished by an overall-advantageous quality: for example, they are particularly soft. The leathers of the invention comprise copolymer of the invention distributed with particular uniformity over the cross section.

A further aspect of the present invention is the use of the leathers of the invention for producing apparel, furniture or automotive parts. Apparel for the purposes of the present invention is, for example, jackets, pants, shoes, belts or suspenders. Furniture in the context of the present invention means all pieces of furniture which include leather components. Examples that may be mentioned include seating, such as chairs, including armchairs, and sofas. Automobile seats may be mentioned as examples of automotive parts.

A further aspect of the present invention is apparel comprising or produced from leathers of the invention. A further aspect of the present invention is furniture comprising or produced from leathers of the invention. A further aspect of the present invention is automotive parts comprising or produced from leathers of the invention.

A further aspect of the present invention is the use of the copolymers of the invention as an additive to detergents, and also a method of cleaning textile substrates using the copolymers of the invention.

Copolymers of the invention are suitable with advantage as an additive to detergents, particularly to cleaning products for hard surfaces, such as dishwash detergents and household cleaners, and to laundry detergents.

Copolymers of the invention are particularly notable for the following advantageous performance properties, which make them particularly suitable for use in laundry detergents: they disperse soil particles outstandingly and so prevent the soil from redepositing on the fabric during laundering. In this way they prevent graying of the textiles. In addition, they improve the primary detergency of both solid and, in particular, liquid laundry detergents. This is true in particular for particulate stains, although hydrophobic, oily and greasy fabric stains are also more readily removed. Furthermore, they can be incorporated readily into solid and liquid laundry detergent formulations. It should be emphasized that the stability and homogeneity of liquid laundry detergents are unaffected by copolymers of the invention. No unwanted instances of phase development, clouding, precipitation or color change are observed, even in cases of prolonged storage.

The invention accordingly further provides laundry detergent formulations comprising added copolymers of the invention. The copolymers of the invention can be used in the form of the free acids or in partly or fully neutralized form.

Solid laundry detergent formulations of the invention include in particular the following components:
(a) 0.05 to 20% by weight of at least one copolymer of the invention,
(b) 0.5 to 40% by weight of at least one nonionic, anionic and/or cationic surfactant,
(c) 0.5 to 50% by weight of at least one inorganic builder,
(d) 0 to 10% by weight of an organic cobuilder, and
(e) 0 to 60% by weight of other customary ingredients, such as extenders, enzymes, fragrance, complexing agents, corrosion inhibitors, bleaches, bleach activators, bleaching catalysts, color transfer inhibitors, further graying inhibitors, soil release polyesters, fiber protection and color protection additives, silicones, dyes, bactericides, solubilizers and/or disintegrants,
   the sum of components (a) to (e) being 100% by weight.

Solid laundry detergent formulations of the invention can be in powder, granule, extrudate or tablet form.

Liquid laundry detergent formulations of the invention preferably have the following composition:
(a) 0.05 to 20% by weight of at least one copolymer of the invention,
(b) 0.5 to 40% by weight of at least one nonionic, anionic and/or cationic surfactant,
(c) 0 to 20% by weight of at least one inorganic builder,
(d) 0 to 10% by weight of an organic cobuilder,
(e) 0 to 60% by weight of other customary ingredients, such as soda, enzymes, fragrance, complexing agents, corrosion inhibitors, bleaches, bleach activators, bleaching catalysts, color transfer inhibitors, further graying inhibitors, soil release polyesters, fiber protection and color protection additives, silicones, dyes, bactericides, organic solvents, solubilizers, hydrotropes, thickeners and/or alkanolamines, and
(f) 0 to 99.45% by weight of water.

Particularly suitable nonionic surfactants (b) include the following:
alkoxylated C₈-C₂₂ alcohols, such as fatty alcohol alkoxylates, oxo alcohol alkoxylates, and Guerbet alcohol alkoxylates: alkoxylation can be with C₂-C₂₀ alkylene oxides, preferably with ethylene oxide, propylene oxide and/or butylene oxide. Block copolymers or random copolymers may be present. Per mole of alcohol they generally include from 1 to 50 mol, preferably from 1 to 20 mol, of at least one alkylene oxide. A particularly preferred alkylene oxide is ethylene oxide. The alcohols have preferably 10 to 18 carbon atoms.
alkylphenol alkoxylates, especially alkylphenol ethoxylates containing C₆-C₄ alkyl chains and from 5 to 30 mol of alkylene oxide/mol.
alkylpolyglucosides containing C₈-C₂₂, preferably C₁₀-C₁₈ alkyl chains and generally 1 to 20, preferably 1.1 to 5, glucoside units.
N-alkylglucamides, fatty acid amide alkoxylates, fatty acid alkanolamide alkoxylates, and block copolymers of ethylene oxide, propylene oxide and/or butylene oxide.

Examples of suitable anionic surfactants include:
sulfates of (fatty) alcohols having 8 to 22, preferably 10 to 18, carbon atoms, especially C₉C₁₁ alcohol sulfates, C₁₂C₁₄ alcohol sulfates, C₁₂-C₁₈ alcohol sulfates, lauryl sulfate, cetyl sulfate, myristyl sulfate, palmityl sulfate, stearyl sulfate, and tallow fatty alcohol sulfate.
sulfated alkoxylated C₈-C₂₂ alcohols (alkyl ether sulfates): compounds of this kind are prepared for example by first alkoxylating a C₈-C₂₂, preferably C₁₀-C₁₈, alcohol, a fatty alcohol for example, and then sulfating the alkoxylation product. Ethylene oxide is preferably used for the alkoxylation.
linear C₈-C₂₀ alkylbenzenesulfonates (LAS), preferably linear C₉-C₁₃ alkylbenzene-sulfonates and alkyltoluenesulfonates.
alkanesulfonates, especially C₈-C₂₄, and preferably C₁₀-C₁₈ alkanesulfonates.
soaps, such as the Na and K salts of C₈-C₂₄ carboxylic acids.

Anionic surfactant is added to the laundry detergent preferably in the form of salts. Examples of suitable cations in this case include alkali metal ions, such as sodium, potassium, and lithium, and ammonium salts, such as hydroxyethylammonium, di(hydroxyethyl)ammonium, and tri(hydroxyethyl)ammonium salts.

Particularly suitable cationic surfactants include:
C₇-C₂₅ alkylamines;
N,N-dimethyl-N-(hydroxy-C₇-C₂₅ alkyl)ammonium salts;
mono- and di-(C₇-C₂₅ alkyl)dimethylammonium compounds quaternized with alkylating agents;
ester quats, especially quaternary esterified mono-, di-, and tri-alkanolamines esterified with C₈-C₂₂ carboxylic acids;
imidazoline quats, particularly 1-alkylimidazolinium salts of formula IX or X 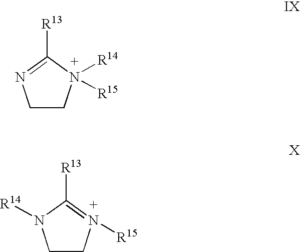
where
R¹³ is identical or different at each occurrence and is selected from C₁-C₂₅ alkyl and C₂-C₂₅ alkenyl;
R¹⁴ is C₁-C₄ alkyl or hydroxy-C₁-C₄ alkyl;
R¹⁵ is C₁-C₄ alkyl, hydroxy-C₁-C₄ alkyl or a radical R¹⁶—(CO)—X—(CH₂)ₚ—(X=—O— or —NH—; p=2 or 3); and
R¹⁶ is selected from C₇-C₂₂ alkyl.

Suitable inorganic builders include in particular:
crystalline and amorphous alumino silicates having ion exchange properties, such as particularly zeolites: various types of zeolite are suitable, particularly zeolites A, X, B, P, MAP, and HS in their Na form or in forms in which some Na has been replaced by other cations such as Li, K, Ca, Mg or ammonium.
crystalline silicates, such as particularly disilicates and phyllosilicates, e.g., δ- and β-Na₂Si₂O₅. The silicates can be used in the form of their alkali metal, alkaline earth metal or ammonium salts; preference is given to Na, Li and Mg silicates.
amorphous silicates, such as sodium metasilicate and amorphous disilicate.
carbonates and hydrogen carbonates: these can be used in the form of their alkali metal, alkaline earth metal or ammonium salts. Preference is given to Na, Li and Mg carbonates and hydrogen carbonates, particularly sodium carbonate and/or sodium hydrogen carbonate.
polyphosphates, such as pentasodium triphosphate.

Particularly suitable organic cobuilders include:
low molecular mass carboxylic acids, such as citric acid, hydrophobically modified citric acid, e.g., agaricic acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids, aminopolycarboxylic acids, e.g., nitrilotriacetic acid, β-alanine diacetic acid, ethylenediaminetetraacetic acid, serinediacetic acid, isoserinediacetic acid, N-(2-hydroxyethyl)iminodiacetic acid, ethylenediaminedisuccinic acid, and methyl- and ethylglycinediacetic acid.
oligomeric and polymeric carboxylic acids, such as homopolymers of acrylic acid and aspartic acid, oligomaleic acids, copolymers of maleic acid with acrylic acid, methacrylic acid or C₂-C₂₂ olefins, e.g., isobutene or long-chain α-olefins, vinyl C₁-C₈ alkyl ethers, vinyl acetate, vinyl propionate, (meth)acrylic esters of C₁-C₈ alcohols and styrene, copolymers of acrylic acid with methacrylic acid or C₂-C₂₂ olefins, e.g., isobutene or long-chain α-olefins, vinyl C₁-C₈ alkyl ethers, vinyl acetate, vinyl propionate, (meth)acrylic esters of C₁-C₈ alcohols and styrene. Preference is given to the homopolymers of acrylic acid and copolymers of acrylic acid with maleic acid. The oligomeric and polymeric carboxylic acids are used in the acid form or as the sodium salt.

Examples of suitable bleaches include adducts of hydrogen peroxide with inorganic salts, such as sodium perborate monohydrate, sodium perborate tetrahydrate, and sodium carbonate perhydrate, and percarboxylic acids, such as phthalimidopercaproic acid.

Examples of suitable bleach activators include N,N,N′,N′-tetraacetylethylenediamine (TAED), sodium p-nonanoyloxybenzenesulfonate, and N-methylmorpholinium acetonitrile methylsulfate.

Enzymes used with preference in laundry detergents are proteases, lipases, amylases, cellulases, oxidases, and peroxidases.

Examples of suitable color transfer inhibitors include homopolymers, copolymers, and graft polymers of 1-vinylpyrrolidone, 1-vinylimidazole or 4-vinylpyridine N-oxide. 4-Vinylpyridine homopolymers and copolymers reacted with chloroacetic acid are also suitable color transfer inhibitors.

Further laundry detergent ingredients are known. Detailed descriptions can be found in, for example, WO 99/06524 and WO 99/04313, and “Liquid Detergents”, Editor: Kuo-Yann Lai, Surfactant Sci. Ser., Vol.67, Marcel Decker, New York, 1997, p.272-304. It has also been found that copolymers of the invention and aqueous dispersions or solutions of copolymer of the invention can be used as dispersants and scale inhibitors in hard surface cleaners. The present invention accordingly provides for the use of copolymers of the invention and of aqueous dispersions or solutions of copolymer of the invention as additives to hard surface cleaners. The present invention additionally provides hard surface cleaners comprising copolymer of the invention. Further provided by the present invention is a method of cleaning hard surfaces using copolymer of the invention or aqueous dispersions or solutions of copolymer of the invention.

Hard surface cleaners are intended to embrace, for example, cleaners for metals, plastics, glass, and ceramics, floor cleaners, toilet cleaners, general purpose cleaners for household and commercial applications, industrial cleaners (for use in car wash installations or high-pressure cleaners), cold cleaners, dishwash detergents, rinse aids, disinfecting cleaners, cleaners for the food and beverage industry, particularly in the form of bottle cleaners, CIP cleaners (Cleaning-in-Place) in dairies, breweries and other food and drink manufacturers' plants. Cleaners comprising copolymer of the invention are particularly suitable for cleaning hard surfaces such as glass, plastic, and metal. The cleaners can be in alkaline, acidic or neutral formulations. They normally contain one or more surfactants in amounts of about 0.2 to 50% by weight. These surfactants can be anionic, nonionic or cationic surfactants or else mixtures of mutually compatible surfactants, examples being mixtures of anionic and nonionic or of cationic and nonionic surfactants. Alkaline cleaners may comprise sodium carbonate, potash, sodium hydrogen carbonate, potassium hydrogen carbonate, sodium sesquicarbonate, potassium sesquicarbonate, sodium hydroxide, potassium hydroxide, amine bases such as monoethanolamine, diethanolamine, triethanolamine or ammonia or silicate in amounts up to 60% by weight, in some cases even up to 80% by weight. Hard surface cleaners of the invention may further contain citrates, gluconates or tartrates in amounts up to 80% by weight. Hard surface cleaners of the invention can be in solid or liquid form.

In one embodiment of the present invention copolymer of the invention is present in hard surface cleaners of the invention in amounts of from 0.1 to 20%, preferably from 0.2 to 15%, by weight.

The invention is illustrated by working examples.

1. Synthesis Instructions for Copolymerization and Esterification

Unless indicated otherwise, all reactions were conducted under a nitrogen atmosphere.

The K values of the copolymers of the invention were determined by the method of H. Fikentscher, Cellulose-Chemie, Volume 13, 58-64 and 761-774 (1932), in aqueous solution at 25° C. and a polymer concentration of 2% by weight. The APHA color numbers of the copolymers of the invention were determined in accordance with Hazen. The APHA color numbers indicated in table 1 were measured using a LICO 200 instrument from Dr. Lange. In that case the samples were in the form of 33% strength by weight aqueous solutions.

1.1. Copolymers Cop1 to Cop10

108 g (1.10 mol) of maleic anhydride were dissolved in x₁ g (x₂ mol) of the alcohol alkoxylate (D) and the solution was heated to 90° C. with stirring under nitrogen. At this temperature 6 g of tert-butyl peroctoate in solution in y₁ g (y₂ mol) of the alcohol alkoxylate (D), and a solution of 0.54 g of hydroquinone monomethyl ether in z₁ g (z₂ mol) of styrene, were added slowly dropwise over the course of two hours. The reaction mixture obtained was then stirred at 90° C. for one hour and subsequently at 120° C. for 4 hours, forming a brown oil. This oil was cooled to 50° C., taken up in 500 g of water, and admixed with a₁ g of an aqueous hydrogen peroxide solution (30% by weight). The solution was adjusted to a pH of 6 to 7 using 50% by weight sodium hydroxide solution. 10 minutes of stirring at 50° C. were followed by the addition of a₂ g of ascorbic acid. The reaction mixture was stirred at 50° C. for two hours and subsequently cooled to room temperature.

This gave solutions of copolymers of the invention having a concentration of from 30 to 50% by weight and a thin viscosity. Further details are summarized in table 1.

Alcohol alkoxylates (D) employed were as follows:
D1: polyethylene glycol monomethyl ether with an average molecular weight Mₙ of 350 g/mol
D2: polyethylene glycol monomethyl ether with an average molecular weight Mₙ of 500 g/mol
D3: polyethylene glycol monomethyl ether with an average molecular weight Mₙ of 1000 g/mol
D4: polyalkylene mono-n-butyl ether (EO+PO) with an average molecular weight Mₙ of 1000 g/mol
D5: ethoxylated C₁₃-C₁₅ alcohol (7 mol EO/mole)

D6: ethoxylated and propoxylated C₁₃-C₁₅ alcohol (4 mol PO/mole, 16 mol EO/mole, random)

TABLE 1

| | | x₁ [g] | y₁ [g] | z₁ [g] | a₁ [g]/a₂ | APHA | |
|---|---|---|---|---|---|---|---|
| Copolymer | D | (x₂ [mol]) | (y₂ [mol]) | (z₂ [mol]) | [g] | color no. | K value |
| Cop1 | D1 | 230 (0.66) | 155 (0.44) | 114 (1.10) | 20/0 | 86 | 33 |
| Cop2 | D2 | 330 (0.66) | 220 (0.44) | 114 (1.10) | 19/1.9 | 28 | 31 |
| Cop3 | D2 | 500 (1.00) | 50 (0.10) | 112 (1.08) | 23/0 | 74 | 31 |
| Cop4 | D2 | 500 (1.00) | 50 (0.10) | 104 (1.00) | 18/1.8 | 124 | 32 |
| Cop5 | D2 | 365 (0.73) | 20 (0.04) | 114 (1.10) | 15/1.5 | 39 | 44 |
| Cop6 | D3 | 660 (0.66) | 440 (0.44) | 114 (1.10) | 20/0 | 77 | 27 |
| Cop7 | D4 | 660 (0.66) | 440 (0.44) | 112 (1.08) | 25/0 | 94 | 21 |
| Cop8 | D5 | 440 (0.88) | 110 (0.22) | 108 (1.04) | 18/1.8 | 81 | 32 |
| Cop9 | D6 | 750 (0.66) | 500 (0.44) | 114 (1.10) | 30/0 | 55 | 18 |
| Cop10 | D6 | 400 (0.32) | 12.5 (0.01) | 112 (1.08) | 15/1.5 | 33 | 38 |

Abbreviations used: EO: ethylene oxide, PO: propylene oxide
1.2. Copolymers Cop11 and Cop12

108 g (1.10 mol) of maleic anhydride were dissolved in a mixture of x₁ g (x₂ mol) of the alcohol alkoxylate (D) and y₁ g (y₂ mol) of a second alcohol alkoxylate (D) and the solution was heated to 90° C. with stirring under nitrogen. At this temperature 6 g of tert-butyl peroctoate in solution in 5 ml of the first alcohol alkoxylate (D), and a solution of 0.54 g of hydroquinone monomethyl ether in z₁ g (z₂ mol) of styrene, were added slowly dropwise over the course of two hours. The reaction mixture obtained was then stirred at 90° C. for one hour and subsequently at 120° C. for 4 hours, forming a brownish oil. This oil was cooled to 50° C., taken up in 700 g of water, and admixed with a₁ g of an aqueous hydrogen peroxide solution (30% by weight). The solution was adjusted to a pH of 6 to 7 using 50% by weight sodium hydroxide solution. 10 minutes of stirring at 50° C. were followed by the addition of a₂ g of tartaric acid. The reaction mixture was stirred at 50° C. for two hours and subsequently cooled to room temperature.

This gave solutions of copolymers of the invention having a concentration of from 30 to 50% by weight and a thin viscosity. Further details are summarized in table 2.

Alcohol alkoxylates (D) employed were as follows:
D2: polyethylene glycol monomethyl ether with an average molecular weight Mₙ of 500 g/mol
D5: ethoxylated C₁₃-C₁₅ alcohol (7 mol EO/mole)

D7: polyethylene glycol monomethyl ether having an average molecular weight Mₙ of 2000 g/mol

TABLE 2

| | | x₁ [g] | y₁ [g] | z₁ [g] | a₁ [g]/a₂ | APHA | K |
|---|---|---|---|---|---|---|---|
| Copolymer | D | (x₂ [mol]) | (y₂ [mol]) | (z₂ [mol]) | [g] | color no. | value |
| Cop11 | D2/D7 | D2 | D7 | 112 (1.08) | 20/0 | 54 | 28 |
| | | 275 (0.55) | 280 (0.14) | | | | |
| Cop12 | D2/D5 | D2 | D5 | 112 (1.08) | 19/1.9 | 49 | 33 |
| | | 440 (0.88) | 111 (0.22) | | | | |

1.3. Copolymers Cop13 and Cop14

108 g (1.10 mol) of maleic anhydride were dissolved in 550 g (1.10 mol) of D2 and the solution was heated to 95° C. with stirring under nitrogen. At this temperature 6 g of tert-butyl peroctoate in solution in 5 ml of the alcohol alkoxylate (D), and a solution of 0.54 g of hydroquinone monomethyl ether in 112 g (1.08 mol) of styrene, were added slowly dropwise over the course of two hours. The reaction mixture obtained was then stirred at 95° C. for one hour and admixed with x₁ g of acid. The reaction mixture was stirred at 95° C. for y₃ hours, forming a brown oil. This oil was cooled to 50° C., taken up in 700 g of water, and admixed with 18 g of an aqueous hydrogen peroxide solution (30%). The solution was adjusted to a pH of 6 to 7 using 50% by weight sodium hydroxide solution. The reaction mixture was stirred at 50° C. for two hours and subsequently cooled to room temperature.

This gave solutions of copolymers of the invention having a concentration of from 30 to 50% by weight and a thin viscosity. Further details are summarized in table 3.

TABLE 3

| | | | | APHA | |
|---|---|---|---|---|---|
| Copolymer | Acid | x₁ [g] | y₃ [h] | color no. | K value |
| Cop13 | p-toluenesulfonic acid | 7.7 | 1.0 | 55 | 23 |
| Cop14 | methanesulfonic acid | 3.8 | 0.5 | 68 | 22 |

1.4. Copolymers Cop15 to Cop17

108 g (1.10 mol) of maleic anhydride were dissolved in x₁ g (x₂ mol) of D and the solution was heated to 95° C. with stirring under nitrogen. At this temperature 6 g of tert-butyl peroctoate in solution in 5 ml of alcohol alkoxylate (D), and a solution of 0.54 g of hydroquinone monomethyl ether and y₁ g (y₂ mol) of acrylic acid in z₁ g (z₂ mol) of styrene, were added slowly dropwise over the course of two hours. The reaction mixture obtained was then stirred at 95° C. for one hour and subsequently at 120° C. for 4 hours, forming a brown oil. This oil was cooled to 50° C., taken up in 700 g of water, and admixed with 18 g of an aqueous hydrogen peroxide solution (30% by weight). The solution was adjusted to a pH of 6 to 7 using 50% by weight sodium hydroxide solution. The reaction mixture was stirred at 50° C. for two hours and subsequently cooled to room temperature.

This gave copolymer solutions with a concentration of 48% by weight and a thin viscosity.

TABLE 4

| | | x₁ [g] | y₁ [g] | z₁ [g] | APHA | K |
|---|---|---|---|---|---|---|
| Copolymer | D | (x₂ [mol]) | (y₂ [mol]) | (z₂ [mol]) | color no. | value |
| Cop15 | D2 | 550 (1.10) | 16 (0.22) | 92 (0.88) | 74 | 51 |
| Cop16 | D3 | 550 (0.55) | 16 (0.22) | 92 (0.88) | 85 | 50 |
| Cop17 | D5 | 555 (1.10) | 16 (0.22) | 92 (0.88) | 105 | 40 |

### COMPARATIVE EXAMPLE C2:

The process described in EP-A 0 945 473 (Nat. Starch) (preparation example 7) was used to prepare a copolymer of styrene, maleic anhydride, CARBOWAX 550, NEODOL 25-9, and NEODOL 25-7 (1/1/1.3/0.04/0.10). The APHA color number was 236.

II. Performance Testing

2.1. Application in the Retanning of Leather—Production of Shoe Upper Leather

A commercial cattle wetblue (from Packer, USA) was shaved to a thickness of 1.8-2.0 mm and cut into six strips each of about 1000 g. The strips were subsequently placed in a drum (30 l) with a liquor length of 200% by weight and admixed at 10-minute intervals with 2% by weight sodium formate and 0.4% by weight NaHCO₃ and with 1% by weight of a naphthalenesulfonic acid-formaldehyde condensate prepared according to U.S. Pat. No. 5,186,846, example “dispersant 1”. After 90 minutes the liquor was drained off. The strips were then distributed to separate drumming barrels.

Together with 100% by weight of water, barrels 1 to 6 were each treated at 25 to 35° C. with 1% by weight of a 50% by weight (solids content) aqueous solution of dyes, the solids of which had the following composition:
70 parts by weight dye from EP-B 0 970 148, Example 2.18,
30 parts by weight Acid Brown 75 (iron complex), Colour Index 1.7.16;
and drummed in the barrel for 10 minutes.

Correspondingly, tanning barrels 5 to 8 were each charged with 100% by weight of water and 1% by weight of a 50% by weight aqueous solution of the dye from DE-A 197 40 473, Example 4.3.

Subsequently, as indicated in table 5, 6% by weight of inventive copolymer as per table 1 was added, followed by 4% by weight of sulfone tanning agent from EP-B 0 459 168, example K1. The strips were then drummed in the barrel for 45 minutes at 15 revolutions/min. Thereafter 2% by weight of vegetable tanning agent Mimosa® was added. After 30 minutes a further 1.5% by weight of the respective dye was added.

Acidification then took place to a pH of 3.6-3.8, using formic acid. After 20 minutes the liquors were evaluated by an optical method for exhaustion and then drained off. The leathers were subsequently washed with 200% by weight of water. Finally, 6% by weight of a Lipoderm-licker® CMG fatliquor was metered into 100% of water at 50° C. After a drumming time of 45 minutes, acidification was effected with 1% by weight formic acid, and the leathers were washed with water.

The washed leathers were dried and staked.

They exhibited excellent plumpness and grain tightening in combination with excellent body coloring of the fibers and also an outstanding levelness over the whole area (distribution of fatliquor and dye).

In addition, very good liquor stability was observed.

TABLE 5
Inventive copolymers employed

| Drum | Copolymer |
|---|---|
| 1 | Cop 1 |
| 2 | Cop 2 |
| 3 | Cop 3 |
| 4 | Cop 4 |
| 5 | Cop 5 |
| 6 | Cop 10 |

2.2 Application as an Additive to Laundry Detergents

The primary and secondary detergency of inventive copolymers was determined.

For the laundering tests two pulverulent laundry detergent formulations (WM 1 and 2) and one liquid laundry detergent formulation (WM 3) were used, the composition of which is reproduced in table 6. The laundering conditions are set out in table 7.

TABLE 6

| | WM 1 | WM 2 | WM 3 |
|---|---|---|---|
| Ingredients | [% by wt.] | [% by wt.] | [% by wt.] |
| n-C₁₂H₂₅—C₆H₄SO₃Na | 5.0 | 12.0 | 17.4 |
| n-C₁₃H₂₇O(CH₂—CH₂O)₇H | 5.0 | 3.0 | |
| n-C₁₂H₂₅O(CH₂—CH₂O)₇H | | | 5.4 |
| Soap | 1.4 | | |
| Coconut fatty acid | | | 1 |
| Zeolite A | 30.0 | 20.0 | |
| Sodium carbonate | 14.0 | 15.0 | 0.5 |
| Sodium metasilicate × 5 H₂O | 3.6 | 10 | |
| Sodium perborate tetrahydrate | 21.0 | | |
| Tetraacetylethylenediamine | 6.0 | | |
| CMC | 1.2 | 1.0 | |
| Sodium cumenesulfonate | | | 1.5 |
| Sodium sulfate | 4.5 | 36.5 | |
| Water | to 100 | to 100 | to 100 |

“to 100 ” means that the composition is made up to 100% by weight.

TABLE 7
Laundering conditions

| Apparatus | Launder-o-meter from Atlas, Chicago, USA |
|---|---|
| Wash liquor | 250 ml |
| Wash duration | 30 min at 40° C. |
| Detergent dose | WM 1: 4.5 g/l |
| | WM 2: 1.5 g/l |
| | WM 3: 1.5 g/l |
| Water hardness | WM 1: 3 mmol/l Ca:Mg:HCO₃ 4:1:8 |
| | WM 2 and WM 3: 1 mmol/l Ca:Mg:HCO₃ 3:2:8 |
| Liquor ratio | WM 1: 1:12.5 |
| | WM 2 and WM 3: 1:20 |
| Wash cycles | 1 |
| Copolymer addition | 2.5% by weight, based on respective WM |
| Test fabric | 2.5 g cotton fabric 221 (bleached, grammage 132 g/m²) (“BW 221”) |
| | Fisat |
| | 2.5 g blend fabric 768 (65:35 PES:cotton, bleached, grammage |
| | 155 g/m²) (“MG 768”) |
| Soil fabric | 5 g cotton fabric 290 (twill, bleached, grammage 193 g/m²) (“BW |
| | 290”) |
| | stained with a 1:1:1 mixture of 3 varieties of clay |
| | (Na/Al silicate fraction of the soil fabric: 4.53% by weight) |
| Clay varieties | Niederahr red firing clay 178/RI |
| | Hessen brown firing manganese clay 262 |
| | Yellow firing clay 158/G |
| | all from Jager KG, Hilgert, Germany |
| Ballast fabric | WM 1: 10 g polyester ballast fabric |
| | WM 2 and WM 3: 2.5 g polyester ballast fabric |

In order to determine the primary detergency the whiteness of the soil fabric was measured before and after laundering, using a Datacolor photometer (Elrepho® 2000) by reference to the reflectance (%). The higher the reflectance, the better the primary detergency.

The results obtained are summarized in table 8.

TABLE 8
Results of laundering experiments (primary detergency)

| | Addition of copolymer | Cotton 290 |
|---|---|---|
| Detergent | (2.5% by weight) | Reflectance in % |
| unlaundered | | 17.1 |
| WM 1 | None | 25.1 |
| WM 1 | Cop 7 | 27.3 |
| WM 1 | Cop 9 | 27.1 |
| WM 1 | Cop 15 | 28.6 |
| WM 2 | None | 24.5 |
| WM 2 | Cop 1 | 26.6 |
| WM 2 | Cop 2 | 27.4 |
| WM 2 | Cop 3 | 29.0 |
| WM 2 | Cop 6 | 28.3 |
| WM 2 | Cop 13 | 27.9 |
| WM 2 | Cop 15 | 28.1 |
| WM 3 | None | 24.2 |
| WM 3 | Cop 3 | 26.7 |

In order to determine the secondary detergency, the graying of the white test fabrics was measured by determining the whiteness before and after laundering, using a photometer from Datacolor (Elrepho® 2000), on the basis of the reflectance (%). The higher the drop in whiteness, the greater the graying of the fabric, and vice versa. The results obtained are summarized in table 9.

TABLE 9
Results of the laundering experiments (secondary detergency)

| | | Cotton 221 | Blend fabric 768 |
|---|---|---|---|
| | Addition of copolymer | Reflectance in | Reflectance in |
| Detergent | (2.5% by weight) | % | % |
| unlaundered | | 83.2 | 84.9 |
| WM 1 | None | 63.7 | 62.5 |
| WM 1 | Cop 1 | 67.0 | 65.7 |
| WM 1 | Cop 2 | 67.9 | 65.8 |
| WM 1 | Cop 3 | 66.5 | 68.0 |
| WM 1 | Cop 5 | 66.2 | 64.5 |
| WM 1 | Cop 6 | 71.6 | 67.7 |
| WM 1 | Cop 7 | | |
| WM 1 | Cop 9 | | |
| WM 1 | Cop 15 | 68.5 | 68.5 |
| WM 1 | Cop 16 | 67.7 | 67.0 |
| WM 1 | Cop 17 | 67.1 | 65.7 |
| WM 2 | None | 61.1 | 61.1 |
| WM 2 | Cop 1 | 63.5 | 65.6 |
| WM 2 | Cop 2 | 64.9 | 65.6 |
| WM 2 | Cop 3 | 64.5 | 63.6 |
| WM 2 | Cop 5 | 65.1 | 66.8 |
| WM 2 | Cop 6 | 64.1 | 63.5 |
| WM 2 | Cop 7 | 64.2 | 63.7 |
| WM 2 | Cop 13 | 64.9 | 64.4 |
| WM 2 | Cop 15 | 65.1 | 66.3 |
| WM 3 | None | 63.5 | 62.8 |
| WM 3 | Cop 2 | 65.9 | 67.1 |
| WM 3 | Cop 3 | 66.5 | 68.0 |
| WM 3 | Cop 5 | 66.6 | 67.5 |
| WM 3 | Cop 7 | 65.3 | 67.0 |
| WM 3 | Cop 13 | 67.2 | 69.3 |
| WM 3 | Cop 15 | 67.3 | 68.5 |

1. A process for preparing a copolymer which comprises copolymerizing
(A) at least one ethylenically unsaturated dicarboxylic anhydride (A) derived from at least one dicarboxylic acid having 4 to 8 carbon atoms,
(B) at least one vinylaromatic compound, and
(C) optionally at least one non-(A) ethylenically unsaturated comonomer containing at least one heteroatom,
(D) reacting the copolymer with at least one compound of the formula I a or I b 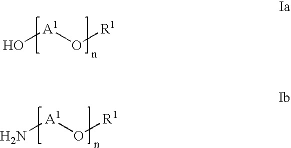
where
A¹ is C₂-C₂₀ alkylene, identical or different,
R¹ is C₁-C₃₀ alkyl, linear or branched, and
n is an integer from 1 to 200,
hydrolyzing the product with water or an aqueous alkaline solution, and
subsequent to hydrolysis adding further initiator.

2. A process as claimed in claim 1, wherein (B) is styrene.

3. A process as claimed in claim 1, wherein the molar ratio of (A) to (C) is from 1:0 to 1:10.

4. A process as claimed in claim 1, wherein the molar ratio of (A) to [(B)+(C)] is from 2:1 to 1:20.

5. A process as claimed in claim 1, wherein (C) is selected from ethylenically unsaturated C₃-C₈ carboxylic acid derivatives of the formula II, 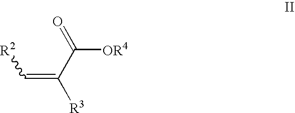
carboxamides of the formula III, 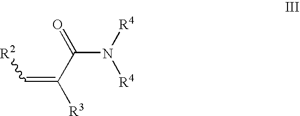
noncyclic amides of the formula IV a and cyclic amides of the formula IV b, 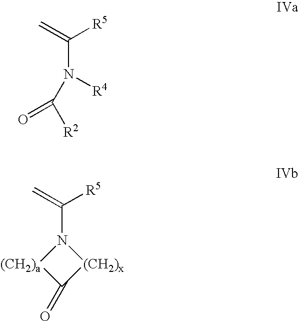
C₁-C₂₀ alkyl vinyl ethers,
N-vinyl derivatives of aromatic nitrogen compounds,
α,β-unsaturated nitrites,
alkoxylated unsaturated ethers of the formula V, 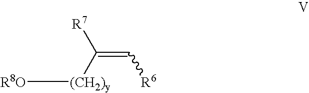
esters or amides of the formula VI, 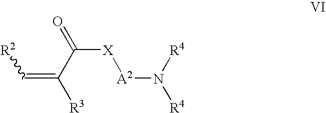
unsaturated esters of the formula VII, 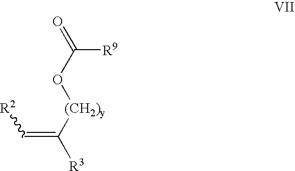
and
phosphate-, phosphonate-, sulfate-, and sulfonate-functional comonomers,
where
A² is C₂-C₂₀ alkylene
R² and R³ are identical or different and are selected from hydrogen and branched or unbranched C₁-C₅ alkyl,
R⁴ is identical or different at each occurrence and is selected from hydrogen and C₁-C₂₂ alkyl, branched or unbranched,
R⁵ is hydrogen or methyl,
x is an integer from 2 to 6,
y is an integer 0 or 1,
a is an integer from 0 to 6,
R⁶ and R⁷ are identical or different and are selected from hydrogen and branched or unbranched C₁-C₁₀ alkyl,
X is oxygen or N—R⁴,
R⁸ is [A¹—O]ₙ—R⁴,
R⁹ is identical or different at each occurrence and is selected from hydrogen and branched or unbranched C₁-C₁₀-alkyl, and
the remaining variables are as defined above.

6. A process as claimed in claim 1, wherein the hydrolysis is conducted at temperatures in the range from 15 to 100° C.

7. A process as claimed in claim 1, wherein (A) and (D) are introduced initially and (B) and, where used, (C) are metered in during the copolymerization.

8. A copolymer obtainable by a process as claimed in claim 1.

9. A copolymer as claimed in claim 8, whose 33% strength by weight aqueous solution has a Hazen color number of not more than 150.

10. An aqueous dispersion or solution comprising a copolymer as claimed in claim 9.

11. The method of using the copolymer as claimed in claim 8 or an aqueous dispersion or solution thereof for producing leather.

12. A process for producing leather using a copolymer as claimed in claim 8 or an aqueous dispersion or solution thereof.

13. Leather produced by a process as claimed in claim 12.

14. The method of using leather as claimed in claim 13 for producing apparel, furniture or automotive parts.

15. The method of using a copolymer as claimed in claim 8 or an aqueous dispersion or solution thereof as an additive to detergent.

16. A detergent comprising a copolymer as claimed in claim 8 or an aqueous dispersion or solution thereof.

17. A method of cleaning textile substrates using a copolymer as claimed in claim 8 or an aqueous dispersion or solution thereof.

18. The method of using a copolymer as claimed in claim 8 or an aqueous dispersion or solution thereof as an additive to hard surface cleaner.

19. A hard surface cleaner comprising a copolymer as claimed in claim 8 or an aqueous dispersion or solution thereof.

20. A method of cleaning hard surfaces using a copolymer as claimed in claim 8 or an aqueous dispersion or solution thereof.
